(19) United States
(12) Patent Application Publication
(10) Pub. No.: US 2020/0104332 A1
(43) Pub. Date: Apr. 2, 2020

(54) RECOMMENDING CONTENT ITEMS TO USERS OF A DIGITAL MAGAZINE SERVER BASED ON TOPICS IDENTIFIED FROM CONTENT OF THE CONTENT ITEMS AND USER INTERACTION WITH CONTENT ITEMS

(71) Applicant: Flipboard, Inc., Redwood City, CA (US)

(72) Inventors: Arnab Bhadury, Vancouver (CA); Aanchan Kumar Mohan, Vancouver (CA)

(21) Appl. No.: 16/586,928

(22) Filed: Sep. 28, 2019

Related U.S. Application Data
(60) Provisional application No. 62/739,327, filed on Sep. 30, 2018.

(51) Int. Cl. G06F 16/9535; G06F 16/903; G06F 16/9035; G06F 16/908

(52) U.S. Cl. CPC G06F 16/9535; G06F 16/908; G06F 16/9035; G06F 16/90348

(57) ABSTRACT

A digital magazine server maintains information describing interactions with content items presented to users of the digital magazine server via digital magazines. Additionally, the digital magazine server maintains a model that associates topics with content items based on characteristics of digital magazines including the content items and characteristics of the content items. To improve recommendation of content items to users, the digital magazine server combines a model recommending content items based on maintained user interactions with the model associating topics with content items based on characteristics of the content items and of digital magazines including the content items. For example, the combined model generates a value for a content item that decreases a value obtained from prior user interactions with the content item by a reduction term based on one or more topics associated with the content item.

### CROSS-REFERENCE TO RELATED APPLICATIONS

This application claims the benefit of U.S. Provisional Application No. 62/739,327, filed Sep. 30, 2018, which is incorporated by reference in its entirety.

### BACKGROUND

This invention relates generally to selecting content for inclusion in a digital magazine and more specifically to using prior user interactions with content items and topics associated with the content items to select content items for inclusion in a digital magazine.

An increasing amount of content is provided to users through digital distribution channels. While this allows users to more easily access a range of content, the increasing amount of content often makes it difficult for a user to identify content most likely to be of interest to the user. Online systems often employ various methods to recommend content items to users or to select content for presentation to different users.

Various online systems use content filtering to recommend content items to users, where different content items are represented by corresponding topics. Based on user interactions with different content items, an online system determines users' affinities for topics corresponding to the different content items. Subsequently, the online system selects content items for a user based on the topics representing the content items and the user's affinities for the topics representing the content items.

Other online systems use collaborative filtering to recommend content items to users. Based on implicit interactions with various content items by users (e.g., accessing or viewing a content item) as well as explicit interactions with various content items by users (e.g., a user indicating a preference for a content item, a user sharing a content item with another user). Hence, as users interact with content items provided by the online system, the online system selects content for a user based on characteristics of the user and of other users who interacted with different content items.

However, effective content filtering involves significant resources to generate a model that identifies topics corresponding to various content items. Collaborative filtering is strongly dependent on amounts of user interaction with content provided by an online system, and may result in increased numbers of user complaints regarding presentation of low quality content items to users. Additionally, collaborative filtering methods have limited effectiveness when an online system has received limited interactions from users with content items, causing inaccurate selection of content items having limited user interaction.

### SUMMARY

A digital magazine server receives content items from various sources or information identifying content items maintained by various sources. Users of the digital magazine server provide the digital magazine server with information identifying various digital magazines. Each digital magazine maintained by the digital magazine server includes one or more content items identified by a user or the digital magazine server. The digital magazine server determines a relative layout of content items included in the digital magazine based on characteristics of the content items and page templates maintained by the digital magazine server.

Additionally, the digital magazine server maintains various characteristics of the digital magazines. In various embodiments, the digital magazine server stores an identifier of a digital magazine in association with identifiers of content items included in the digital magazine, along with a title and a description of the digital magazine. The title and the description of the digital magazine are received from a user who provided the digital magazine server with information identifying the digital magazine. To simplify inclusion of content items in digital magazines, the digital magazine server associates topics with content items, allowing users to more easily identify content items for inclusion in digital magazines associated with particular topics. In various embodiments, the digital magazine server analyzes characteristics of content items and associates topics with the content items based on those characteristics.

The digital magazine server generates and maintains a topic model that associates topics with content items based on characteristics of the content items. For example, the digital magazine trains a topic model that uses characteristics of digital magazines including a content item as well as text or other data comprising the content item to determine topics associated with the content item. In various embodiments, the digital magazine server generates the topic model by identifying a set of content items and identifying characteristics of each digital magazine in which the content item is included. In various embodiments, the digital magazine server identifies a title and a description associated with the content item of the set. For example, the digital magazine server retrieves an identifier of the content item and determines an identifier of each digital magazine including the content item. Using the identifiers of the digital magazines including the content item, the digital magazine server identifies characteristics of each digital magazine including the content item. For example, the digital magazine server identifies a title and a description of each digital magazine including the content item.

From the characteristics of each digital magazine including a content item of the set and a number of occurrences of different words or phrases in content items maintained by or accessible to the digital magazine server, the digital magazine server generates the topic model, which applies topics to content items based on characteristics of the content items. In various embodiments, the topic model based on a Dirichlet distribution determined from a concept prior that specifies an initial estimation of a mixture of topics. Additionally, in various embodiments, application of the topic model to a content item generates topics associated with the content items from words of the content items and also generates probabilities of the generated topics being associated with the content item.

Additionally, as users of the digital magazine server interact with content items presented to the users, the digital magazine server receives information describing interactions by the users with various content items. For example, the digital magazine server receives an identifier of a content item, an identifier of a user, and an interaction performed by the user with the content item. Example interactions by a user with a content item include: indicating a preference for the content item, indicating a reaction to the content item, sharing the content item with another user, including the content item in a digital magazine, accessing the content item, viewing the content item, and hiding the content item. The digital magazine server stores information describing an interaction in association with the content item on which the interaction was performed and with the user who performed the interaction. For example, the digital magazine server stores a description of an interaction in association with an identifier of a content item and with an identifier of a user. The digital magazine server retrieves information maintained by the digital magazine server describing characteristics of the users (e.g., information maintained in a user profile of the user, prior interactions with content items by the user) and characteristics of content items with which the users performed various interactions and generates an interaction model that determines a relevance of a content item to a user based on characteristics of the user, characteristics of the content item, and prior interactions by the user (as well as other users) with content items.

To improve selection of content items for a user, the digital magazine server generates a combined model based on the topic model. In various embodiments, the digital magazine server augments the interaction model with a value generated from the topic model to generate the combined model. For example, the value generates a reduction term from application of the topic model to characteristics of a content item and decreases a relevance of a content item to a user determined from characteristics of the users (e.g., information maintained in a user profile of the user, prior interactions with content items by the user) and characteristics of content items with which the users performed various interactions based on the reduction term. This augments the measure of relevance of a content item to a user with information from the content of the content item (i.e., topics associated with the content item), allowing the combined model to more organically account for affinity of a user to topics included in the content item using the topics associated with the content item, increasing quality of content items selected for presentation to the user.

### BRIEF DESCRIPTION OF THE DRAWINGS

FIG. 1 is a block diagram of a system environment in which a digital magazine server operates, in accordance with an embodiment of the invention.

FIG. 2 is a block diagram of an architecture of the digital magazine server, in accordance with an embodiment of the invention.

FIG. 3 is an example presentation of content items in a digital magazine using a page template, in accordance with an embodiment of the invention.

FIG. 4 is a process flow diagram of a method for generating a model that selects content items for a user based on topics associated with content items and prior interactions with content items by users, in accordance with an embodiment of the invention.

FIG. 5 is a flowchart of a method for generating a model that selects content items for a user based on topics associated with content items and prior interactions with content items by users, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A digital magazine server retrieves content from one or more sources and generates a personalized, customizable digital magazine for a user based on the retrieved content. For example, based on selections made by the user and/or on behalf of the user, the digital server application generates a digital magazine with one or more sections including content items retrieved from a number of sources and personalized for the user. A digital magazine application executing on a computing device (such as a mobile communication device, tablet, computer, or any other suitable computing system) retrieves the generated digital magazine and presents it to the user. The generated digital magazine allows the user to more easily consume content that interests and inspires the user by presenting content items in an easily navigable interface via a computing device.

The digital magazine may be organized into a number of sections that each include content having a common characteristic (e.g., content obtained from a particular source). For example, a section of the digital magazine includes articles from an online news source (such as a website for a news organization), another section includes articles from a third-party-curated collection of content associated with a particular topic (e.g., a technology compilation), and an additional section includes content obtained from one or more accounts associated with the user and maintained by one or more social networking systems. For purposes of illustration, content included in a section is referred to herein as “content items” or “articles,” which may include textual articles, pictures, videos, products for sale, user-generated content (e.g., content posted on a social networking system), advertisements, and any other types of content capable of display within the context of a digital magazine.

### System Architecture

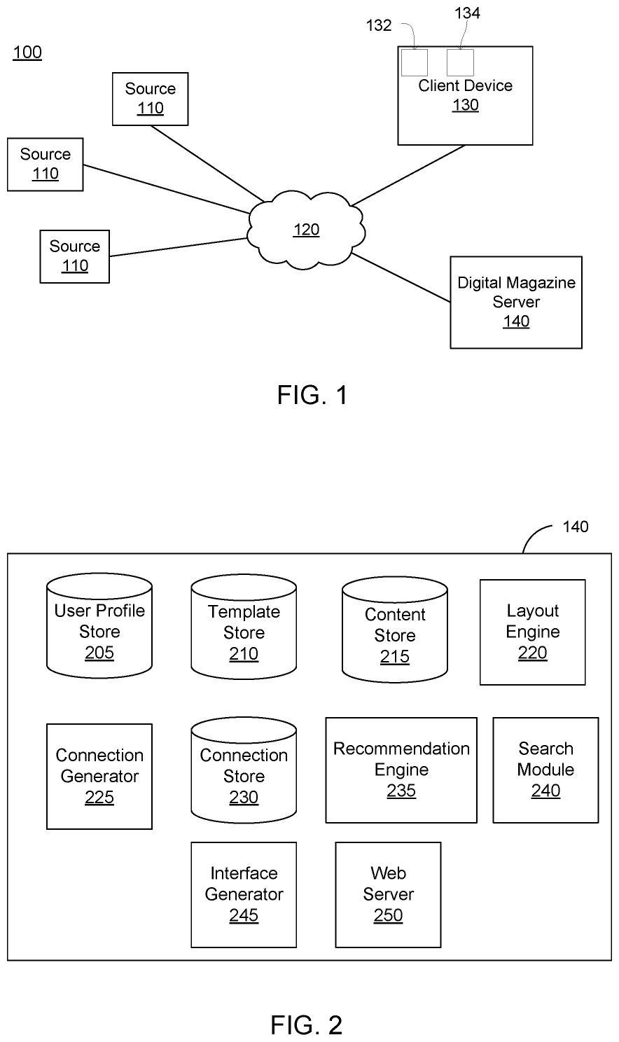

FIG. 1 is a block diagram of a system environment 100 for a digital magazine server 140. The system environment 100 shown by FIG. 1 comprises one or more sources 110, a network 120, a client device 130, and the digital magazine server 140. In alternative configurations, different and/or additional components may be included in the system environment 100. The embodiments described herein can be adapted to online systems that are not digital magazine servers 140.

A source 110 is a computing system capable of providing various types of content to a client device 130. Examples of content provided by a source 110 include text, images, video or audio on web pages, web feeds, social networking information, messages, and other suitable data. Additional examples of content include user-generated content such as blogs, tweets, shared images, video or audio, social networking posts, and social networking status updates. Content provided by a source 110 may be received from a publisher (e.g., stories about news events, product information, entertainment, or educational material) and distributed by the source 110, or a source 110 may be a publisher of content it generates. For convenience, content from a source, regardless of its composition, may be referred to herein as an “article,” a “content item,” or as “content.” An article or a content item may include various types of content, such as text, images, and video.

The sources 110 communicate with the client device 130 and the digital magazine server 140 via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML), extensible markup language (XML), or JavaScript Object Notation (JSON). In some embodiments, all or some of the communication links of the network 120 may be encrypted using any suitable technique or techniques.

The client device 130 is one or more computing devices capable of receiving user input as well as transmitting and/or receiving data via the network 120. In one embodiment, the client device 130 is a conventional computer system, such as a desktop or laptop computer. Alternatively, the client device 130 may be a device having computer functionality, such as a personal digital assistant (PDA), a mobile telephone, a smartphone, or another suitable device. In one embodiment, the client device 130 executes an application allowing a user of the client device 130 to interact with the digital magazine server 140. For example, the client device 130 executes an application that communicates instructions or requests for content items to the digital magazine server 140 and presents the content to a user of the client device 130. As another example, the client device 130 executes a browser that receives pages from the digital magazine server 140 and presents the pages to a user of the client device 130. In another embodiment, the client device 130 interacts with the digital magazine server 140 through an application programming interface (API) running on a native operating system of the client device 130, such as IOS® or ANDROID™. While FIG. 1 shows a single client device 130, in various embodiments, any number of client devices 130 may communicate with the digital magazine server 140.

A display device 132 included in the client device 130 presents content items to a user of the client device 130. Examples of the display device 132 include a liquid crystal display (LCD), an organic light emitting diode (OLED) display, an active matrix liquid crystal display (AMLCD), or any other suitable device. Different client devices 130 may have display devices 132 with different characteristics. For example, different client devices 130 have display devices 132 with different display areas, different resolutions, or differences in other characteristics.

One or more input devices 134 included in the client device 130 receive input from the user. The client device 130 may include different input devices 134. In one embodiment, the client device 130 includes a touch-sensitive display for receiving input data, commands, or information from a user. In other embodiments, the client device 130 includes a keyboard, a trackpad, a mouse, or any other device capable of receiving input from a user. Additionally, in some embodiments, the client device may include multiple input devices 134. Inputs received via the input device 134 may be processed by a digital magazine application associated with the digital magazine server 140 and executing on the client device 130 to allow a client device user to interact with content items presented by the digital magazine server 140.

The digital magazine server 140 retrieves content items from one or more sources 110, generates pages in a digital magazine by processing the retrieved content, and provides the pages to the client device 130. As further described below in conjunction with FIG. 2, the digital magazine server 140 generates one or more pages for presentation to a user based on content items retrieved from one or more sources 110 and information describing organization and presentation of content items. For example, the digital magazine server 140 determines a page layout positioning content items relative to each other based on information associated with a user and generates a page including the content items positioned according to the determined layout for presentation to the user via the client device 130. This allows the user to access content items via the client device 130 in a format that enhances the user's interaction with and consumption of the content items. For example, the digital magazine server 140 provides a user with content items in a format similar to the format used by print magazines. By presenting content items in a format similar to that of a print magazine, the digital magazine server 140 allows a user to interact with content items from multiple sources 110 via the client device 130 more easily than when scrolling horizontally or vertically to access various content items.

FIG. 2 is a block diagram of an architecture of the digital magazine server 140. The digital magazine server 140 shown in FIG. 2 includes a user profile store 205, a template store 210, a content store 215, a layout engine 220, a connection generator 225, a connection store 230, a recommendation engine 235, a search module 240, an interface generator 245, and a web server 250. In other embodiments, the digital magazine server 140 may include additional, fewer, or different components for various applications. Conventional components such as network interfaces, security functions, load balancers, failover servers, management and network operations consoles, and the like are not shown so as to not obscure the details of the system architecture.

Each user of the digital magazine server 140 is associated with a user profile, which is stored in the user profile store 205. A user profile includes declarative information about the user that was explicitly shared by the user and may also include profile information inferred by the digital magazine server 140. In one embodiment, a user profile includes multiple data fields, each describing one or more attributes of the corresponding digital magazine server user. Examples of information stored in a user profile include biographic, demographic, and other types of descriptive information, such as hobbies or preferences, location, or other suitable information. A user profile in the user profile store 205 also includes data describing interactions by a corresponding user with content items presented by the digital magazine server 140. For example, a user profile includes a content item identifier, a description of an interaction with the content item corresponding to the content item identifier, and a time when the interaction occurred.

While user profiles in the user profile store 205 are frequently associated with individuals, user profiles may also be associated with entities such as businesses or organizations. This allows an entity to provide or access content items via the digital magazine server 140. An entity may post information about itself or its products, or provide other content items associated with the entity to users of the digital magazine server 140. For example, users of the digital magazine server 140 may receive a digital magazine or section including content items provided by an entity via the digital magazine server 140.

The template store 210 includes page templates each describing a spatial arrangement (“layout”) of content items relative to each other on a page for presentation to a user by a client device 130. A page template includes one or more slots, each configured to present one or more content items. In some embodiments, slots in a page template may be configured to present a particular type of content item or a content item having one or more specified characteristics. For example, a slot in a page template is configured to present an image while another slot in the page template is configured to present text. Each slot has a size (e.g., small, medium, or large) and an aspect ratio. One or more page templates may be associated with types of client devices 130, allowing content items to be presented in different locations and at different sizes when the content items are viewed on different client devices 130. Additionally, page templates may be associated with sources 110, allowing a source 110 to specify the format of pages presenting content items retrieved from the source 110. For example, a page template associated with an online retailer allows the online retailer to present content items via the digital magazine server 140 with a specific organization. Examples of page templates are further described in U.S. patent application Ser. No. 13/187,840, filed on Jul. 21, 2011, and U.S. patent application Ser. No. 13/938,227, filed on Jul. 9, 2013, each of which is hereby incorporated by reference in its entirety.

The content store 215 stores objects that each represent various types of content. For example, the content store 215 stores content items received from one or more sources 110 within a threshold time interval. Examples of content items stored by the content store 215 include a page post, a status update, an image, a photograph, a video, a link, an article, video data, audio data, a check-in event at a location, or any other type of content. A user may specify a section including content items having a common characteristic, in which case the common characteristic is stored in the content store 215 along with an association with the user profile or the user specifying the section.

The layout engine 220 retrieves content items from one or more sources 110 or from the content store 215 and generates a layout including the content items based on a page template from the template store 210. Based on the retrieved content items, the layout engine 220 may identify candidate page templates from the template store 210 and score the candidate page templates based on characteristics of the slots in different candidate page templates and based on characteristics of the content items. Based on the scores associated with candidate page templates, the layout engine 220 selects a page template and associates the retrieved content items with one or more slots to generate a layout where the retrieved content items are positioned relative to each other and sized based on their associated slots. When associating a content item with a slot, the layout engine 220 may associate the content item with a slot configured to present a specific type of content item or content items having one or more specified characteristics. Examples of using a page template to present content items are further described in U.S. patent application Ser. No. 13/187,840, filed on Jul. 21, 2011, U.S. patent application Ser. No. 13/938,223, filed on Jul. 9, 2013, and U.S. patent application Ser. No. 13/938,226, filed on Jul. 9, 2013, each of which is hereby incorporated by reference in its entirety.

The connection generator 225 monitors interactions between users and content items presented by the digital magazine server 140. Based on the interactions, the connection generator 225 determines connections between various content items, connections between users and content items, or connections between users of the digital magazine server 140. For example, the connection generator 225 identifies when users of the digital magazine server 140 provide feedback about a content item, access a content item, share a content item with other users, or perform other actions with content items. In some embodiments, the connection generator 225 retrieves data describing a user's interactions with content items from the user's user profile in the user profile store 205. Alternatively, user interactions with content items are communicated to the connection generator 225 when the interactions are received by the digital magazine server 140. The connection generator 225 may account for temporal information associated with user interactions with content items. For example, the connection generator 225 identifies user interactions with a content item within a specified time interval or applies a decay factor to identified user interactions based on times associated with the interactions. The connection generator 225 generates a connection between a user and a content item if the user's interactions with the content item satisfy one or more criteria. In one embodiment, the connection generator 225 determines one or more weights specifying a strength of the connection between the user and the content item based on the user's interactions with the content item that satisfy one or more criteria. Generation of connections between a user and a content item is further described in U.S. patent application Ser. No. 13/905,016, filed on May 29, 2013, which is hereby incorporated by reference in its entirety.

If multiple content items are connected to a user, the connection generator 225 establishes implicit connections between each of the content items connected to the user. In one embodiment, the connection generator 225 maintains a user content graph identifying the implicit connections between content items connected to the user. In one embodiment, weights associated with connections between a user and content items are used to determine weights associated with various implicit connections between the content items. User content graphs for multiple users of the digital magazine server 140 are combined to generate a global content graph identifying connections between various content items provided by the digital magazine server 140 based on user interactions with various content items. For example, the global content graph is generated by combining user content graphs based on mutual connections between various content items in user content graphs.

In one embodiment, the connection generator 225 generates an adjacency matrix from the global content graph or multiple user content graphs and stores the adjacency matrix in the connection store 230. The adjacency matrix describes connections between content items. For example, the adjacency matrix includes identifiers of content items and weights representing the strength or closeness of connections between content items. As an example, the weights indicate a degree of similarity in subject matter or other characteristics associated with various content items. In other embodiments, the connection store 230 includes various adjacency matrices determined from various user content graphs; the adjacency matrices may be analyzed to generate an overall adjacency matrix for content items retrieved by the digital magazine server 140. Graph analysis techniques may be applied to the adjacency matrix to rank content items, to recommend content items to a user, or to otherwise analyze relationships between content items. An example of the adjacency matrix is further described in U.S. patent application Ser. No. 13/905,016, filed on May 29, 2013, which is hereby incorporated by reference in its entirety.

In addition to identifying connections between content items, the connection generator 225 may also determine a social proximity between users of the digital magazine server 140 based on interactions between users and content items. The digital magazine server 140 determines social proximity, or “social distance,” between users using a variety of techniques. For example, the digital magazine server 140 analyzes additional users connected to each of two users of the digital magazine server 140 within a social networking system to determine the social proximity of the two users. In another example, the digital magazine server 140 determines social proximity between a user and an additional user by analyzing the user's interactions with content items posted by the additional user, whether presented using the digital magazine server 140 or another social networking system. Additional examples for determining social proximity between users of the digital magazine server 140 are described in U.S. patent application Ser. No. 13/905,016, filed on May 29, 2013, which is incorporated by reference in its entirety. In one embodiment, the connection generator 225 determines a connection confidence value between a user and an additional user of the digital magazine server 140 based on the user's and the additional user's common interactions with particular content items. The connection confidence value may be a numerical score representing a measure of closeness between the user and the additional user. For example, a larger connection confidence value indicates a greater similarity between the user and the additional user. In one embodiment, if a user has at least a threshold connection confidence value with another user, the digital magazine server 140 stores a connection between the user and the additional user in the connection store 230.

Using data from the connection store 230, the recommendation engine 235 identifies content items from one or more sources 110 for recommending to a digital magazine server user. Hence, the recommendation engine 235 identifies content items potentially relevant to a user. In one embodiment, the recommendation engine 235 retrieves data describing interactions between a user and content items from the user's user profile, connections between content items, and/or connections between users from the connection store 230. In one embodiment, the recommendation engine 235 uses stored information describing content items (e.g., topic, sections, subsections) and interactions between users and various content items (e.g., views, shares, saved, links, topics read, or recent activities) to identify content items that may be of interest to a digital magazine server user. For example, content items having an implicit connection of at least a threshold weight to a content item with which the user interacted are recommended to the user. As another example, the recommendation engine 235 presents a user with content items having one or more attributes in common with a content item with which an additional user having a threshold connection confidence score with the user interacted. Recommendations for additional content items may be presented to a user when the user views a content item using the digital magazine, as a notification to the user by the digital magazine server 140, or to the user through any suitable communication channel.

In one embodiment, the recommendation engine 235 applies various filters to content items received from one or more sources 110 or from the content store 215 to efficiently provide a user with recommended content items. For example, the recommendation engine 235 analyzes attributes of content items in view of characteristics of a user from the user's user profile. Examples of attributes of content items include a type (e.g., image, story, link, video, audio, etc.), a source 110 from which a content item was retrieved, time when a content item was retrieved, and subject matter of a content item. Examples of characteristics of a user include biographic information about the user, users connected to the user, and interactions between the user and content items. In one embodiment, the recommendation engine 235 analyzes attributes of content items in view of a user's characteristics for a specified time period to generate a set of recommended content items. The set of recommended content items may be presented to the user or further analyzed based on user characteristics and on content item attributes to generate a more refined set of recommended content items. A setting included in a user's user profile may specify a length of time that content items are analyzed before identifying recommended content items to the user, allowing a user to balance refinement of recommended content items with time used to identify recommended content items.

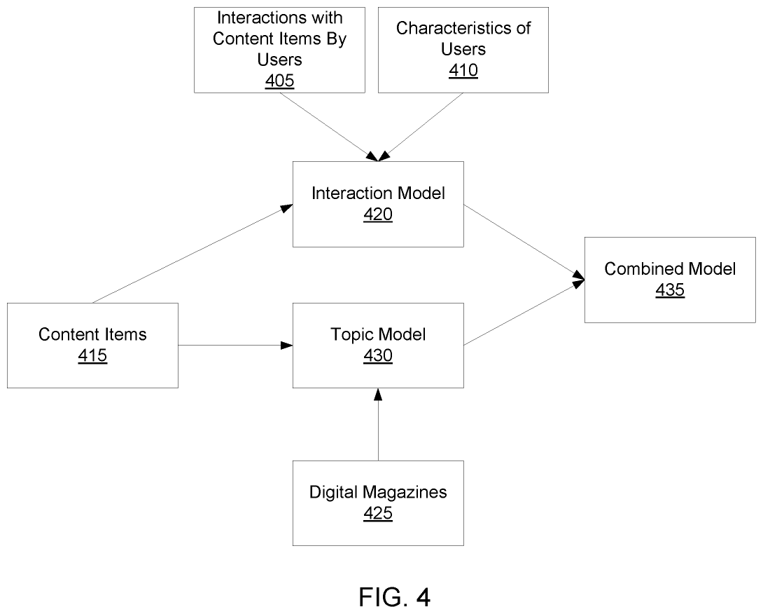

As further described below in conjunction with FIG. 4, in various embodiments the recommendation engine 235 generates a model for selecting content items for presentation to users that is based on prior interactions with content items as well as topics associated with content items. For example, the recommendation engine 235 obtains a topic model that determines topics or concepts associated with content items based on words or phrases included in content items. In various embodiments, a concept is associated with one or more topics, allowing the recommendation engine 235 to maintain a hierarchy of concepts or topics as well as to determine relationships between concepts and topics. As described above, the recommendation engine 235 uses similarities between topics or concepts associated with content items presented to a user, or associated with content items with which the user interacted, to recommend other content items to the user. Hence, the topic model uses characteristics of content items and characteristics of digital magazines including the content items to associate topics with content items.

Additionally, the recommendation engine obtains an interaction model that retrieves stored interactions with content items by various users of the online system as well as characteristics of the users who performed the retrieved interactions. Based on characteristics of users who interacted with content items, characteristics of a user, and characteristics of content items, the interaction model determines a relevance of a content item to the user, which the recommendation engine 235 uses to determine whether to select the content item for presentation to the user. To improve recommendation of content items to users, the recommendation engine 235 generates a combined model from the topic model and the interaction model; hence, the combined model accounts for user interactions with content items as well as topics associated with content items based on characteristics of the content items and characteristics of digital magazines including the content items. As further described in the attached appendix to the specification, an embedding for a user is determined based on the interaction model, as well as a relationship between the embedding for a user and an embedding for a content item. The embedding for the user has multiple dimensions that each have values based on different characteristics of the users, such as different interactions performed by the user. The embedding for the content item similarly has multiple dimensions, with each dimension corresponding to a topic; in various embodiments, a value of a dimension of the embedding for the content item is a probability of a topic corresponding to the dimension being associated with the content item or is a number of times the topic corresponding to the dimension is associated with the content item. The recommendation engine 235 applies a function to the embedding of the content item in the relationship between the embedding for the user and for the content item. For example, the recommendation engine 235 scales an embedding of the content item by a constant and applies a softmax function to the scaled embedding of the content item, which converts the scaled embedding of the content item to a multi-dimensional vector of real values that each have a value between 0 and 1 and a sum of the values of the multi-dimensional vector is 1. An embodiment of a relationship between embeddings for a user and embeddings for a content item is further described in the attached appendix to the specification. From the relationship between embeddings for content items and embeddings for users, the recommendation engine 235 generates the combined model, as further described below in conjunction with FIG. 4 and in the attached appendix to the specification. Subsequently, the recommendation engine applies the combined model to characteristics of users and characteristics of content items to determine measures of relevance of different content items to a user and selects content items for recommendation to the user based on the measures of relevance.

The search module 240 receives a search query from a user and retrieves content items from one or more sources 110 based on the search query. For example, content items having at least a portion of an attribute matching at least a portion of the search query are retrieved from one or more sources 110. The user may specify sources 110 from which content items are retrieved through settings maintained by the user's user profile or by specifying one or more sources in the search query. In one embodiment, the search module 240 generates a section of the digital magazine including the content items identified based on the search query, as the identified content items have a common attribute of their association with the search query. Presenting identified content items from a search query in a section of the digital magazine allows a user to more easily identify additional content items at least partially matching the search query when additional content items are provided by sources 110.

To more efficiently identify content items based on search queries, the search module 240 may index content items, groups (or sections) of content items, and user profile information. In one embodiment, the index includes information about various content items, such as author, source, topic, creation data/time, user interaction information, document title, or other information capable of uniquely identifying the content item. Search queries are compared to information maintained in the index to identify content items for presentation to a user. The search module 240 may present identified content items based on a ranking. One or more factors associated with the content items may be used to generate the ranking. Examples of factors include global popularity of a content item among users of the digital magazine server 140, connections between users interacting with a content item and the user providing the search query, and information from a source 110. Additionally, the search module 240 may assign a weight to the index information associated with each content item based on similarity between index information and a search query and rank the content items based on their weights. For example, content items identified based on a search query are presented in a section of the digital magazine in an order based in part on the ranking of the content items.

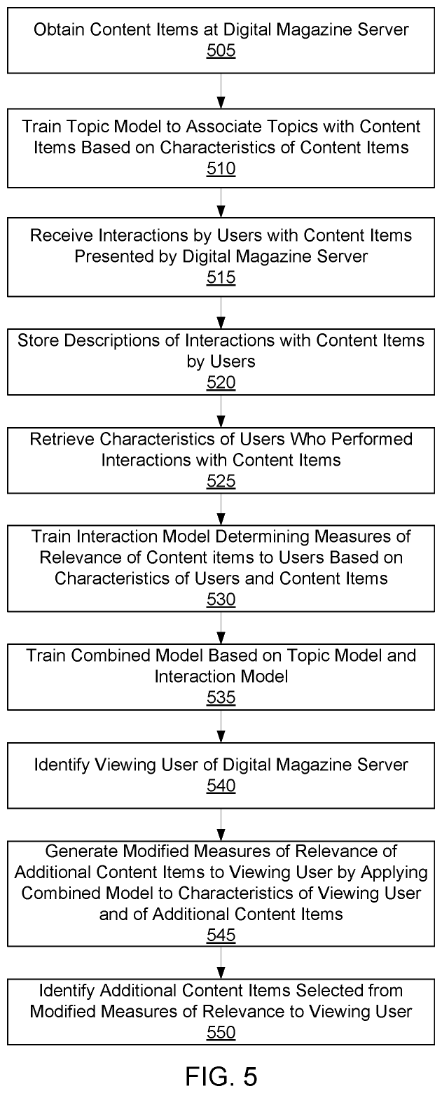

To increase user interaction with the digital magazine, the interface generator 245 maintains instructions associating received input with actions performed by the digital magazine server 140 or by a digital magazine application executing on a client device 130. For example, instructions maintained by the interface generator 245 associate types of inputs or specific inputs received via an input device 132 of a client device 130 with modifications to content presented by a digital magazine. As an example, if the input device 132 is a touch-sensitive display, the interface generator 245 maintains instructions associating different gestures with navigation through content items or presented via a digital magazine. Instructions maintained by the interface generator 245 are communicated to a digital magazine application or other application executing on a client device 130 on which content from the digital magazine server 140 is presented. In various embodiments, the interface generator 245 communicates instructions to a client device 130 identifying topics or concepts associated with a content item and probabilities of the topics or concepts being associated with the content item; the generated interface also includes options for a user to whom the interface is presented to increase or decrease the probability of a topic or a concept being associated with the content item by interacting with an option included in the interface, as further described below in conjunction with FIG. 5.

The web server 250 links the digital magazine server 140 via the network 120 to the one or more client devices 130, as well as to the one or more sources 110. The web server 250 serves web pages, as well as other content, such as JAVA®, FLASH®, XML, and so forth. The web server 250 may retrieve content items from one or more sources 110. Additionally, the web server 250 communicates instructions for generating pages of content items from the layout engine 220 and instructions for processing received input from the interface generator 245 to a client device 130. The web server 250 also receives requests for content or other information from a client device 130 and communicates the request or information to components of the digital magazine server 140 to perform corresponding actions. Additionally, the web server 250 may provide application programming interface (API) functionality to send data directly to native client device operating systems, such as IOS®, ANDROID™, WEBOS®, or BlackberryOS.

For purposes of illustration, FIG. 2 describes various functionalities provided by the digital magazine server 140. However, in other embodiments, the above-described functionality may be provided by a digital magazine application executing on a client device 130 or by a combination of the digital magazine server 140 and a digital magazine application executing on a client device 130.

### Page Templates

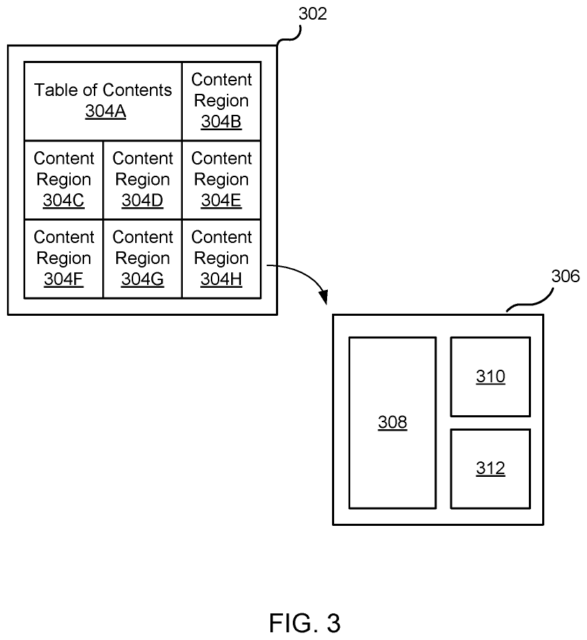

FIG. 3 illustrates an example page template 302 having multiple rectangular slots each configured to present a content item. Other page templates with different configurations of slots may be used by the digital magazine server 140 to present one or more content items received from sources 110. As described above in conjunction with FIG. 2, in some embodiments, one or more slots in a page template are reserved for presentation of a specific type of content item or content items having specific characteristics. In one embodiment, the size of a slot may be specified as a fixed aspect ratio or using fixed dimensions. Alternatively, the size of a slot may be flexible, where the aspect ratio or one or more dimensions of a slot is specified as a range, such as a percentage of a reference or a base dimension. Arrangement of slots within a page template may also be hierarchical. For example, a page template is organized hierarchically, where an arrangement of slots may be specified for the entire page template or for one or more portions of the page template.

In the example of FIG. 3, when a digital magazine server 140 generates a page for presentation to a user of a client device 130, the digital magazine server 140 populates slots in a page template 302 with content items. Information identifying the page template 302 and associations between content items and slots in the page template 302 is stored and used to generate the page. For example, to present a page to a user, the layout engine 220 identifies the page template 302 from the template store 210 and retrieves content items from one or more sources 110 or from the content store 215. The layout engine 220 generates data or instructions associating content items with slots within the page template 302. Hence, the generated page includes various “content regions” presenting one or more content items associated with a slot in a location specified by the slot.

A content region 304 may present image data, text data, a combination of image and text data, or any other information retrieved from a corresponding content item. For example, in FIG. 3, the content region 304A represents a table of contents identifying sections of a digital magazine, and content associated with the various sections are presented in content regions 304B-304H. For example, content region 304A includes text or other data indicating that the presented data is a table of contents, such as the text “Cover Stories Featuring,” followed by one or more identifiers associated with various sections of the digital magazine. In one embodiment, an identifier associated with a section describes a characteristic common to at least a threshold number of content items in the section. For example, an identifier refers to the name of a user of social network from which content items included in the section are retrieved. As another example, an identifier associated with a section specifies a topic, an author, a publisher (e.g., a newspaper, a magazine) or other characteristic associated with at least a threshold number of content items in the section. Additionally, an identifier associated with a section may further specify content items selected by a user of the digital magazine server 140 and organized as a section. Content items included in a section may be related topically and include text and/or images related to the topic.

Sections may be further organized into subsections, with content items associated with one or more subsections presented in content regions 304. Information describing sections or subsections, such as a characteristic common to content items in a section or subsection, may be stored in the content store 215 and associated with a user profile to simplify generation of a section or subsection for the user. A page template 302 associated with a subsection may be identified, and slots in the page template 302 associated with the subsection may be used to determine the presentation of content items from the subsection relative to each other. Referring to FIG. 3, the content region 304H includes a content item associated with a newspaper to indicate a section including content items retrieved from the newspaper. When a user interacts with the content region 304, a page template 302 associated with the section is retrieved, as well as content items associated with the section. Based on the page template 302 associated with the section and the content items, the digital magazine server 140 generates a page presenting the content items based on the layout described by the slots of the page template 302. For example, in FIG. 3, the section page 306 includes content regions 308, 310, 312 presenting content items associated with the section. The content regions 308, 310, 312 may include content items associated with various subsections including content items having one or more common characteristics (e.g., topics, authors, etc.). Hence, a subsection may include one or more subsections, allowing hierarchical organization and presentation of content items by a digital magazine.

Selecting Content Items for a User Based on Topics Associated with Content Items and Prior Interactions with Content Items by Users.

FIG. 4 is a process flow diagram of one embodiment of a method for generating a model that selects content items for a user based on topics associated with content items and prior interactions with content items by users. As described above in conjunction with FIG. 2, a digital magazine server 140 maintains interactions 405 by users with content items presented to the users via the digital magazine server 140. For example, the digital magazine server 140 receives an identifier of a content item, an identifier of a user, and an interaction 405 performed by the user with the content item. Example interactions 405 by a user with a content item include: indicating a preference for the content item, indicating a reaction to the content item, sharing the content item with another user, including the content item in a digital magazine, accessing the content item, viewing the content item, and hiding the content item. The digital magazine server 140 stores information describing an interaction 405 in association with the content item on which the interaction 405 was performed and with the user who performed the interaction. For example, the digital magazine server 140 stores a description of an interaction 405 in association with an identifier of a content item and with an identifier of a user.

Additionally, the digital magazine server 140 maintains characteristics 410 of users of the digital magazine server 140. For example, user profiles included in a user profile store 205 of the digital magazine server 140 include characteristics 410 of users, such as demographic information, location, etc. From interactions 405 by users with content items, characteristics 410 of users maintained by the digital magazine server 140, and characteristics of content items 415, the digital magazine server 140 generates an interaction model 420 that determines a relevance of a content item to a user based on characteristics of the user, characteristics of the content item, and prior interactions by the user (as well as other users) with content items. In various embodiments, the interaction module 420 generates embeddings for users, where an embedding for a user has multiple dimensions that each have values based on different characteristics of the users, including interactions by the user with content items.

Additionally, based on characteristics of content items 415 maintained by the digital magazine server 140 and characteristics of digital magazines 425 maintained by the digital magazine server 140, the digital magazine server 140 generates a topic model 420 that associates topics with content items based on characteristics of the content items. For example, the digital magazine server 140 trains the topic model 430 to use characteristics of digital magazines 425 including a content item 415 as well as text or other data comprising the content item 415 to determine topics associated with the content item 415. In various embodiments, the topic model 430 determines probabilities of different topics being associated with a content item 415 based on words or phrases included in the content item 415, as well as characteristics (e.g., titles, descriptions) of digital magazines 425 that include the content item 415. For example, the digital magazine server 140 generates the topic model 430 by identifying a set of content items 415 and identifying characteristics of each digital magazine 425 in which the content item 415 is included. In various embodiments, the digital magazine server 140 identifies a title and a description associated with the content item 415 of the set. For example, the digital magazine server 140 retrieves an identifier of the content item and determines an identifier of each digital magazine including the content item. Using the identifiers of the digital magazines 425 including the content item 415, the digital magazine server 140 identifies characteristics of each digital magazine 425 including the content item 415. For example, the digital magazine server 140 identifies a title and a description of each digital magazine 425 including the content item 415.

From the characteristics of each digital magazine 425 including a content item 415 of the set and a number of occurrences of different words or phrases in content items maintained by or accessible to the digital magazine server 140, the digital magazine server 140 generates the topic model 430, which associates topics with content items 415 based on characteristics of the content items 415. In various embodiments, the topic model uses a Dirichlet distribution determined from a concept prior that specifies an initial estimation of a mixture of topics to associate topics with content items 415. In various embodiments, application of the topic model 430 to a content item 415 generates topics associated with the content items 415 from words of the content items 415 and also generates probabilities of the generated topics being associated with the content item 415.

To improve selection of content items for a user, the digital magazine server 140 generates a combined model 435 based on the topic model 430 and the interaction module 420. In various embodiments, the digital magazine server 140 augments the interaction model 420 with a value generated from the topic model 430 to generate the combined model 435. For example, the value generated form the topic model 430 comprises a reduction term generated from application of the topic model 430 to characteristics of a content item 415. The combined model 435 decreases a relevance of a content item 415 to a user determined from characteristics of the users 410 and interactions 405 by users with content items as well as characteristics of content items 415 with which the users performed various interactions 405 based on the reduction term.

In various embodiments, the digital magazine server 140 determines a relationship between embeddings for users and embeddings for content items, where an embedding for a content item has multiple dimensions that each correspond to topics and have values based on the corresponding topics. In various embodiments, the relationship between the embedding for the user and the embedding for the content item applies a function to embeddings of content items. For example, the digital magazine server 140 scales an embedding of a content item 415 (e.g., an embedding representing how many times each of a set of topics appeared in a content item) by a constant and applies a function, such as softmax or normalized exponential function, to the scaled embedding of the content item 415. The function applied to the scaled embedding of the content item 415 converts the scaled embedding of the content item to a multi-dimensional vector of real values that each have a value between 0 and 1, where the values of the multi-dimensional vector sum to 1. From the relationship between the embedding for the user and for the content item, the digital magazine server 140 generates the reduction term that decreases a measure of relevance of a content item to a user determined from prior interactions 405 with the content item and from characteristics 410 of users. In various embodiments, the digital magazine server 140 trains the combined model 430 using alternating least squares and Gibbs Sampling and stores the trained combined model 430 for subsequent application to content items 415.

The combined model 430 augments the measure of relevance of a content item 415 to a user based on prior interactions 405 with content items and characteristics 410 of users with information from the content of the content item 415 (i.e., topics associated with the content item), allowing the combined mode 430 to more organically account for affinity of a user to topics included in the content item 415 using the topics associated with the content item. This improves a quality of content items selected for presentation to a user by accounting for topics of the content item, while allowing the combined model 430 to accurately select content for a user with limited interactions 405 with content items have been received by the digital magazine server 140. increasing quality of content items selected for presentation to the user.

FIG. 5 is a flowchart of one embodiment of a method for generating a model that selects content items for a user based on topics associated with content items and prior interactions with content items by users. In various embodiments, the method may include different or additional steps than those described in conjunction with FIG. 5. Additionally, in some embodiments, the method may perform the steps in different orders than the order described in conjunction with FIG. 5.

A digital magazine server 140 obtains 505a set of content items from one or more sources 110. Each content item obtained 505 by the digital magazine server 140 is included in at least one digital magazine maintained by the digital magazine server 140. For example, the digital magazine server 140 obtains 505a content item from a source 110 in conjunction with an identifier of a digital magazine in which the content item is included. In various embodiments, the digital magazine server 140 stores an identifier of a digital magazine in association with identifiers of content items obtained 505 by the digital magazine server 140 that are included in the digital magazine, along with characteristics of the digital magazine, such as a title and a description of the digital magazine. The title and the description of the digital magazine are received from a user or a source 110 who provided the digital magazine server 140 with information identifying the digital magazine.

To simplify inclusion of content items in digital magazines, the digital magazine server 140 associates topics with content items, allowing users to more easily identify content items for inclusion in digital magazines associated with particular topics. In various embodiments, the digital magazine server 140 analyzes characteristics of content items and associates topics with the content items based on those characteristics. To associate topics with content items, the digital magazine server 140 trains 510 and maintains a topic model that associates topics with content items based on characteristics of the content items. For example, the digital magazine server 140 trains a topic model that is applied to characteristics of digital magazines including a content item as well as text or other data comprising the content item to determine one or more topics associated with the content item. In various embodiments, the digital magazine server 140 trains 510 the topic model by identifying a set of content items and identifying characteristics of each digital magazine including one or more content items of the set. In various embodiments, the digital magazine server 140 identifies a title and a description associated with the content item of the set. For example, the digital magazine server 140 retrieves an identifier of the content item and determines an identifier of each digital magazine including the content item. Using the identifiers of the digital magazines including the content item, the digital magazine server 140 identifies characteristics of each digital magazine including the content item. For example, the digital magazine server 140 identifies a title and a description of each digital magazine including the content item.

From characteristics of each digital magazine including a content item of the set and a number of occurrences of different words or phrases in content items maintained by or accessible to the digital magazine server 140, the digital magazine server trains 510 the topic model, which applies topics to content items based on characteristics of the content items. In various embodiments, the topic model based on a Dirichlet distribution determined from a concept prior specifying initial estimation of a mixture of topics. Additionally, in various embodiments, application of the topic model to a content item generates topics and probabilities of the generated topics being associated with the content items from words of the content item.

In one embodiment, to train 510 the topic model, the digital magazine server 140 determines one or more labels associated with each content item of the set. For example, the digital magazine server 140 determines labels of a content item of the set as noun phrases extracted from titles of digital magazines including the content item. As another example, the digital magazine server 140 determines labels of a content item of the set as noun phrases extracted from a description or a title of the digital magazine including the content item. Hence, the digital magazine server 140 determines one or more labels for each content item of the set based on characteristics (e.g., titles, descriptions) of digital magazines including the content items. The digital magazine server 140 stores the labels in association with the content items of the set for which the labels were determined. In various embodiments, the digital magazine server 140 stores labels determined for a content item of the set in association with an identifier of the content item of the set. The digital magazine server 140 stores a number of times a label is associated with the content item of the set in association with the label and the content item; the number of times the label is associated with the content item of the set provides an indication of a frequency with which the label was identified from characteristics (e.g., titles, descriptions) of digital magazines including the content item. This allows the digital magazine server to store labels associated with each content item of the set.

In some embodiments, the digital magazine server 140 also determines a concept distribution of concepts maintained by the digital magazine server 140 when training 510 the topic model, where each concept includes one or more topics. The digital magazine server 140 also determines a topic distribution of topics maintained by the digital magazine server 140. The concept distribution is a Dirichlet distribution based on a concept prior and a number of concepts maintained by the digital magazine server 140, while the topic distribution is also a Dirichlet distribution based on a topic prior and a number of topics maintained by the digital magazine server 140. The concept prior affects a distribution of words or phrases per concept, while the topic prior affects a distribution of words or phrases per topic. In various embodiments, the concept prior and the topic prior are parameters stored by the digital magazine server 140 or specified by an administrator of the digital magazine server 140. The administrator may specify a concept prior where each concept includes a limited number of labels and may also specify a topic prior where each topic includes a limited number of terms from content items. The digital magazine server 140 concurrently determine the concept distribution and determine the topic distribution in various embodiments, or may determine the concept distribution and determine the topic distribution in any suitable order in various embodiments.

For each content item of the set, the digital magazine server 140 determines a distribution of concepts associated with the content item based on the labels associated with the content item and the number of times the labels were associated with the content item. In various embodiments, the distribution of concepts associated with the content item of the set is a categorical distribution based on a number of labels associated with the content item and numbers of times different labels were associated with the content item. Hence, the distribution of concepts associated with the content item represents probabilities of different concepts being associated with the content item based on the number of times different labels were associated with the content item.

From the distribution of concepts associated with each content item of the set, the digital magazine server 140 determines a parameter defining a relationship between the distribution of concepts associated with the content item and a distribution of topics associated with the content item based on a number of labels associated with the content item. In some embodiments, the parameter is based on a number of labels associated with the content item of the set. For example, the digital magazine server 140 determines the parameter based on a normalized vector of numbers of different labels associated with the content item of the set; the digital magazine server 140 applies one or more factors to the normalized vector of numbers of different labels associated with the content item when determining the parameter defining the relationship between the distribution of concepts associated with the content item and a distribution of topics associated with the content item.

Additionally, for each content item of the set, the digital magazine server 140 determines a distribution of topics associated with the content item based on words included in the content item. In various embodiments, the digital magazine server 140 applies a bag-of-words model to the content item of the set to determine frequencies with which different words are included in the content item, while weighting words by the inverse of their frequency within the content item, and determines the topics associated with the content item as the words based on the frequencies with which different words are included in the content item. For example, the digital magazine server 140 determines topics associated with the content item of the set as words or phrases having at least a threshold frequency of occurrence within the content item. As another example, the digital magazine server 140 uses Compressed Gibbs Sampling to determine topics associated with the content item from the words or phrases in the content item. However, in other embodiments, the digital magazine server 140 uses any suitable method or methods to determine topics associated with the content item of the set based on words included in the content item. In various embodiments, the distribution of topics associated with the content item of the set is a categorical distribution based on a number of occurrences of different words or phrases in the content item. Hence, the distribution of topics associated with the content item of the set represents probabilities of different topics being associated with the content item based on the frequencies with which different words or phrases occur in the content item.

From the distributions of concepts associated with the content items of the set, the distributions of topics associated with the content items of the set, and the parameters defining relationships between the distributions of concepts and the distributions of topics, the digital magazine server 140 trains the topic model applying topics to content items based on characteristics of content items of the set. Application of the topic model to content items generates topics associated with the content items from words of the content items and also generates probabilities of the generated topics being associated with the content items. In various embodiments, the digital magazine server 140 modifies the distributions of concepts associated with content items of the set by removing concepts having less than a threshold position in the distributions of concepts associated with content items. Similarly, the digital magazine server 140 modifies the distributions of topics associated with content items of the set by removing topics having less than a threshold position in the distributions of topics. Using the modified distributions of concepts associated with content items of the set and the modified distributions of concepts associated with topics of the set, the digital magazine server 140 determines modified distributions of concepts associated with each content item of the set based on the labels associated with the content items of the set, determines a modified parameter defining the relationship between the distributions of concepts associated with the content items of the set and the modified distributions of topics associated with content items of the set, and determines modified distributions of topics associated with content items of the set based on words included in the content items of the set. Subsequently the digital magazine server 140 iteratively modifies the distribution of the concepts associated with content items of the set and the distribution of the topics associated with content items of the set and modifies the parameter defining the relationship between the distributions of concepts associated with the content items of the set and the modified distributions of topics associated with content items of the set until one or more criteria are satisfied to train 510 the topic model. For example, the digital magazine server 140 modifies the distribution of the concepts associated with content items of the set and the distribution of the topics associated with content items of the set and modifies the parameter defining the relationship between the distributions of concepts associated with the content items of the set and the modified distributions of topics associated with content items of the set until a negative log-probability of the topic model based at least in part on the parameter decreases at a threshold rate or does not decrease. Based on the iterative modification, the digital magazine server 140 generates a value based on the modifications to the parameters defining relationships between the distributions of concepts associated with the content items of the set and the distributions of topics associated with the content items of the set. In one embodiment, the digital magazine server 140 trains 510 the topic model by generating a distribution of concepts associated with content items from the distributions of the content items and generating a distribution of topics associated with content items from the distributions of topics associated with the content items of the set. The digital magazine server 140 trains the topic model by combining the distribution of concepts associated with content items, and the distribution of topics associated with content items based on a combination of the value based on the modifications to the parameters. However, in other embodiments, the digital magazine 140 may train 510 the topic model using any suitable technique. The digital magazine server 140 subsequently stores the trained topic model.

Additionally, the digital magazine server 140 receives 515 interactions by users of the digital magazine server 140 interact with content items presented to the users. For example, the digital magazine server 140 receives an identifier of a content item, an identifier of a user, and an interaction performed by the user with the content item. Example interactions by a user with a content item include: indicating a preference for the content item, indicating a reaction to the content item, sharing the content item with another user, including the content item in a digital magazine, accessing the content item, viewing the content item, and hiding the content item. The digital magazine server 140 stores 520 descriptions of interactions by users with content items on which the interactions were performed form the received interactions. A description of an interaction by a user with a content item includes an identifier of the content item, an identifier of the user who performed the interaction, and the interaction, allowing the digital magazine server 140 to store 520 the description of the interaction in association with the content item and in association with the user.

The digital magazine server 140 retrieves 525 characteristics of the users who performed various interactions and characteristics of content items on which the users performed the interactions. Example characteristics of a user include information maintained in a user profile of the user, prior interactions with content items by the user, connections between the user and other users or between the user and content items. In some embodiments, the digital magazine server 140 retrieves 525 characteristics of users who performed an interaction with at least one content item within a specific time interval, as well as characteristics of content items which the users interacted. As another example, the digital magazine server 140 retrieves 525 characteristics of users who interacted with content items included in digital magazines having one or more specific characteristics and retrieves 525 characteristics of the content items with which the users interacted.

From the retrieved characteristics of users who interacted with content items and the retrieved characteristics of the content items with which the users interacted, the digital magazine server 140 trains 530 an interaction model. Based on characteristics of a user, characteristics of a content item, and prior interactions by the user, as well as by other users, with content items, the interaction model determines a relevance of the content item to the user. In various embodiments, the digital magazine server 140 trains 530 the interaction model based on prior user interactions with content items previously presented to the users by the digital magazine server 140. For example, the digital magazine server 140 applies a label to a content item previously presented to users indicating one or more interactions by users with the content items to characteristics of users who performed the one or more interactions and characteristics of the content items with which the users interacted. From the labeled characteristics of users who performed interactions with content items and characteristics of content items with which the users interacted, the digital magazine server 140 trains 532 the interaction model using any suitable training method or combination of training methods. The digital magazine server 140 subsequently stores the trained interaction model.

To improve selection of content items for a user, the digital magazine server 140 trains 535a combined model based on the topic model and the interaction model. In various embodiments, the digital magazine server 140 trains 535 the combined model by augmenting the interaction model with a value generated from the topic model. For example, value generated from the topic model is a reduction term from application of the topic model to characteristics of a content item, and the combined model decreases a relevance of a content item to a user determined from characteristics users (e.g., information maintained in a user profile of the user, prior interactions with content items by the user) and characteristics of content items with which the users performed various interactions by the reduction term. In various embodiments, the digital magazine server 140 determines a relationship between embeddings for users and embeddings for content items, where an embedding for a content item has multiple dimensions that each correspond to topics and have values based on the corresponding topics. In various embodiments, the relationship between the embedding for the user and the embedding for the content item applies a function to embeddings of content items. For example, the digital magazine server 140 scales an embedding of a content item (e.g., an embedding representing how many times each of a set of topics appeared in a content item) by a constant and applies a function, such as softmax or normalized exponential function, to the scaled embedding of the content item. The function applied to the scaled embedding of the content item converts the scaled embedding of the content item to a multi-dimensional vector of real values that each have a value between 0 and 1, where the values of the multi-dimensional vector sum to 1. From the relationship between the embedding for the user and for the content item, the digital magazine server 140 generates the reduction term that decreases a measure of relevance of a content item to a user determined from application of the interaction model to characteristics of a user and to characteristics of a content item. In various embodiments, the digital magazine server 140 trains 535 the combined model using alternating least squares and Gibbs Sampling and stores the trained combined model. The combined model augments the measure of relevance of a content item to a user with information from the content of the content item (i.e., topics associated with the content item), allowing the combined model to more organically account for affinity of a user to topics included in the content item using the topics associated with the content item, which increases quality of content items selected for presentation to the user.

After training and storing the combined model, the digital magazine server 140 identifies 540a viewing user of the digital magazine server 140. For example, the viewing user is a user from whom the digital magazine server 140 received a request for a digital magazine or received a request for one or more content items. As another example, the digital magazine server 140 identifies 540 the viewing user as a user who interacted with a digital magazine during a specific time interval (e.g., within a threshold amount of time from a current time). However, in other embodiments, the digital magazine server 140 identifies 540 the viewing user as a user satisfying any suitable criteria.

The digital magazine server 140 retrieves characteristics of the viewing user maintained by the digital magazine server 140 and applies the combined model to the characteristics of the viewing user and to characteristics of additional content items, generating 545 measures of relevance of the additional content items to the viewing user determined by in interaction model and modified by the topic model. In some embodiments, the additional content items are content items obtained 505 by the digital magazine serve 140 during a specific time interval (e.g., content items obtained 505 by the digital magazine server 140 during a threshold time from a current time, content items obtained 505 by the digital magazine server 140 more recently than a most recent interaction with a content item by the viewing user). The digital magazine server 140 may also identify the additional content items as content items associated with digital magazines with which the viewing user has not interacted within a threshold amount of time (or with which the user has not previously interacted) or as content items with which the viewing user has not previously interacted (or with which the user has not interacted within a threshold amount of time). The modified measures of relevance of the additional content items to the viewing user generated 545 by application of the combined model are based on both prior interactions by the viewing user (and other users) with content items and information from the additional content items (i.e., topics associated with different additional content items). Hence, the modified measures of relevance generated 545 by the combined model more organically account for affinity of the viewing user to topics included in various additional content items using the topics associated with the additional content items, so the modified measures of relevance allow the digital magazine server 140 to more accurately select content for a user from whom the digital magazine server 140 previously received limited interactions with presented content items.

From the modified measures of relevance, the digital magazine server 140 identifies 550 one or more of the additional content items selected by the digital magazine server 140 based on the modified measures of relevance to the viewing user. For example, the digital magazine server 140 generates a digital magazine for the presentation to the viewing user that includes additional content items selected by the digital magazine server 140 based on the modified measures of relevance of the additional content items to the viewing user. For example, the digital magazine server 140 generates the digital magazine that identifies 550 additional content items associated with a specific topic and having at least a threshold modified measure of relevance. As another example, the digital magazine server 140 generates the digital magazine by identifying a set of additional content items associated with a specific topic, ranking the additional content items of the set based on their modified measures of relevance, and including additional content items of the set having at least a threshold position in the ranking in the digital magazine. Alternatively, the digital magazine server 140 selects one or more additional content items for the viewing user based on the modified measures of relevance and identifies the selected additional content items to the viewing user. For example, the digital magazine server 140 selects additional content items having at least a threshold modified measure of relevance and transmits a title or other information identifying the selected additional content items to a client device 110 of the viewing user. In another example, the digital magazine server 140 ranks the additional content items based on their modified measures of relevance and selects additional content items having at least a threshold position in the ranking; the digital magazine server 140 transmits a title or other information identifying the selected additional content items to a client device 110 of the viewing user.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
obtaining a set of content items at a digital magazine server each content item of the set included in at least one digital magazine maintained by the digital magazine server and each content item of the set having various characteristics;
training a topic model at the digital magazine server, the topic model identifying one or more topics of a content item from characteristics of the content item;
receiving interactions with one or more content items of the set by users of the digital magazine server at the digital magazine server;
storing, at the digital magazine server, descriptions of interactions by users with one or more content items of the set, a description of an interaction including an identifier of a content item of the set, an identifier of the user who performed an interaction with the content item of the set, and information identifying the interaction;
retrieving characteristics of users who performed one or more interactions with the one or more content items of the set, the characteristics of the users maintained by the digital magazine server;
training an interaction model at the digital magazine server from the descriptions of interactions by users with one or more content items of the set, the retrieved characteristics of users who performed the one or more interactions with the one or more content items of the set, and characteristics of the one or more content items of the set with which the users interacted;
training a combined model that modifies a measure of relevance of the content item to a user of the digital magazine server from the interaction model by a value determined from application of the topic model to the content item;
identifying a viewing user of the digital magazine server;
generating modified measures of relevance of additional content items maintained by the digital magazine server to the viewing user by application of the combined model to characteristics of the viewing user and to characteristics of each of the additional content items; and
identifying one or more of the additional content items selected by the digital magazine server from the modified measures of relevance of the additional content items to the viewing user.

2. The method of claim 1, wherein the combined model decreases the measure of relevance of the content item to a user of the digital magazine server from the interaction model by the value.

3. The method of claim 1, wherein training the combined model that modifies the measure of relevance of the content item to the user of the digital magazine server from the interaction model by the value determined from application of the topic model to the content item comprises:
determining embeddings for each content item of the set, an embedding for the content item having multiple dimensions that each correspond to a topic and that each have a value based on the corresponding topic;
scaling each of the embeddings for the content items of the set by a constant; and
applying a function to the scaled embeddings of the content items of the set that converts a scaled embedding of the content item to a multi-dimensional vector of real values each having a value between 0 and 1; and
determining the value from the multi-dimensional vectors resulting from application of the function to the scaled embeddings of the content items of the set.

4. The method of claim 3, wherein the function comprises a normalized exponential function.

5. The method of claim 3, wherein the real values of the multidimensional vector of the scaled embedding of the content item sum to 1.

6. The method of claim 1, wherein characteristics of the content item of the set comprise a title and a description of a digital magazine including the content item of the set.

7. The method of claim 1, wherein the topic model is based on a Dirichlet distribution determined from a concept prior specifying an initial estimation of a mixture of topics.

8. The method of claim 1, wherein the topic model also generates probabilities of the one or more topics identified for the content item.

9. The method of claim 1, wherein identifying one or more of the additional content items selected by the digital magazine server from the modified measures of relevance of the additional content items to the viewing user comprises:
transmitting information identifying one or more additional content items having at least a threshold modified measure of relevance to a client device of the viewing user.

10. The method of claim 1, wherein identifying one or more of the additional content items selected by the digital magazine server from the modified measures of relevance of the additional content items to the viewing user comprises:
selecting additional content items having a specific topic;
ranking the selected additional content items based on their modified measures of relevance; and
transmitting a digital magazine including selected additional content items having at least a threshold position in the ranking to a client device of the viewing user.

11. A computer program product comprising a non-transitory computer readable storage medium having instructions encoded thereon that, when executed by a processor, cause the processor to:
obtain a set of content items at a digital magazine server each content item of the set included in at least one digital magazine maintained by the digital magazine server and each content item of the set having various characteristics;
train a topic model at the digital magazine server, the topic model identifying one or more topics of a content item from characteristics of the content item;
receive interactions with one or more content items of the set by users of the digital magazine server at the digital magazine server;
store, at the digital magazine server, descriptions of interactions by users with one or more content items of the set, a description of an interaction including an identifier of a content item of the set, an identifier of the user who performed an interaction with the content item of the set, and information identifying the interaction;
retrieve characteristics of users who performed one or more interactions with the one or more content items of the set, the characteristics of the users maintained by the digital magazine server;
train an interaction model at the digital magazine server from the descriptions of interactions by users with one or more content items of the set, the retrieved characteristics of users who performed the one or more interactions with the one or more content items of the set, and characteristics of the one or more content items of the set with which the users interacted;
train a combined model that modifies a measure of relevance of the content item to a user of the digital magazine server from the interaction model by a value determined from application of the topic model to the content item;
identify a viewing user of the digital magazine server;
generate modified measures of relevance of additional content items maintained by the digital magazine server to the viewing user by application of the combined model to characteristics of the viewing user and to characteristics of each of the additional content items; and
identify one or more of the additional content items selected by the digital magazine server from the modified measures of relevance of the additional content items to the viewing user.

12. The computer program product of claim 11, wherein the combined model decreases the measure of relevance of the content item to a user of the digital magazine server from the interaction model by the value.

13. The computer program product of claim 11, wherein train the combined model that modifies the measure of relevance of the content item to the user of the digital magazine server from the interaction model by the value determined from application of the topic model to the content item comprises:
determine embeddings for each content item of the set, an embedding for the content item having multiple dimensions that each correspond to a topic and that each have a value based on the corresponding topic;
scale each of the embeddings for the content items of the set by a constant; and
apply a function to the scaled embeddings of the content items of the set that converts a scaled embedding of the content item to a multi-dimensional vector of real values each having a value between 0 and 1; and
determine the value from the multi-dimensional vectors resulting from application of the function to the scaled embeddings of the content items of the set.

14. The computer program product of claim 13, wherein the function comprises a normalized exponential function.

15. The computer program product of claim 13, wherein the real values of the multidimensional vector of the scaled embedding of the content item sum to 1.

16. The computer program product of claim 11, wherein characteristics of the content item of the set comprise a title and a description of a digital magazine including the content item of the set.

17. The computer program product of claim 11, wherein the topic model is based on a Dirichlet distribution determined from a concept prior specifying an initial estimation of a mixture of topics.

18. The computer program product of claim 11, wherein the topic model also generates probabilities of the one or more topics identified for the content item.

19. The computer program product of claim 11, wherein identify one or more of the additional content items selected by the digital magazine server from the modified measures of relevance of the additional content items to the viewing user comprises:
transmit information identifying one or more additional content items having at least a threshold modified measure of relevance to a client device of the viewing user.

20. The computer program product of claim 11, wherein identify one or more of the additional content items selected by the digital magazine server from the modified measures of relevance of the additional content items to the viewing user comprises:
select additional content items having a specific topic;
rank the selected additional content items based on their modified measures of relevance; and
transmit a digital magazine including selected additional content items having at least a threshold position in the ranking to a client device of the viewing user.
